(19) United States
(12) Patent Application Publication
(10) Pub. No.: US 2011/0137859 A1
(43) Pub. Date: Jun. 9, 2011

(54) Staged Data Conversion

(76) Inventor: David Dickman, Prospect, CT (US)

(21) Appl. No.: 12/633,362

(22) Filed: Dec. 8, 2009

(51) Int. Cl. G06F 17/30

(52) U.S. Cl. 707/610; 707/809; 707/741; 707/E17.005; 707/E17.009; 707/E17.014

(57) ABSTRACT

A device to convert data from a first format to a second format includes a conversion module and a synchronization module. The conversion module converts first production data from the first format to the second format. The synchronization module incrementally loads second production data to the first production data to generate finalized production data. The finalized production data is in the second format.

### BACKGROUND

A computing device may use a variety of different formats to store data. Furthermore, a network which incorporates computing devices may also use a plurality of formats to store data. The format for a computing device may differ to an extent where a translation may be required to save the data into a different format. A first format in which data is stored may also subsequently be upgraded that the data is required to be translated as well. For example, data stored at a wire center may be required to be migrated into a new system. Conventional conversion processes are inefficient and are extremely time consuming, schedule impacting, and running an inherently high risk of data corruption and/or loss.

### SUMMARY OF THE INVENTION

The exemplary embodiments of the present invention describes a device to convert data from a first format to a second format. The device includes a conversion module and a synchronization module. The conversion module converts first production data from the first format to the second format. The synchronization module incrementally loads second production data to the first production data to generate finalized production data. The finalized production data is in the second format.

### DESCRIPTION OF THE DRAWINGS

FIG. 1 shows a data translation device according to an exemplary embodiment.

FIG. 2 shows a method for translating data according to an exemplary embodiment.

### DETAILED DESCRIPTION

The exemplary embodiments may be further understood with reference to the following description and the appended drawings, wherein like elements are referred to with the same reference numerals. The exemplary embodiments describe a system and method for translating data using a staged approach. Specifically, the data to be translated may be for an application that requires the data to be in a different format. The exemplary embodiments may use the staged approach to efficiently convert the data into the proper format. The translation, the staged approach, the formats, and a related method will be discussed in further detail below.

It is noted that the following description uses the terms translating and converting and their variants. Those skilled in the art will understand that in the context of the exemplary embodiments, these terms are used interchangeably to describe the process of changing data from a first form to a second form. Furthermore, it is noted that the exemplary embodiments are described with reference to a data conversion for wire centers in a telecommunications network. However, the exemplary embodiments are not limited to this type of data conversion. Those skilled in the art will understand that the exemplary embodiments may be applied to any type of data. Specifically, it is noted that the exemplary embodiments are not concerned with the specific type of data and/or the formats which the data starts, or the formats into which the data is translated. The exemplary embodiments are concerned with applying a consistent process to the translation.

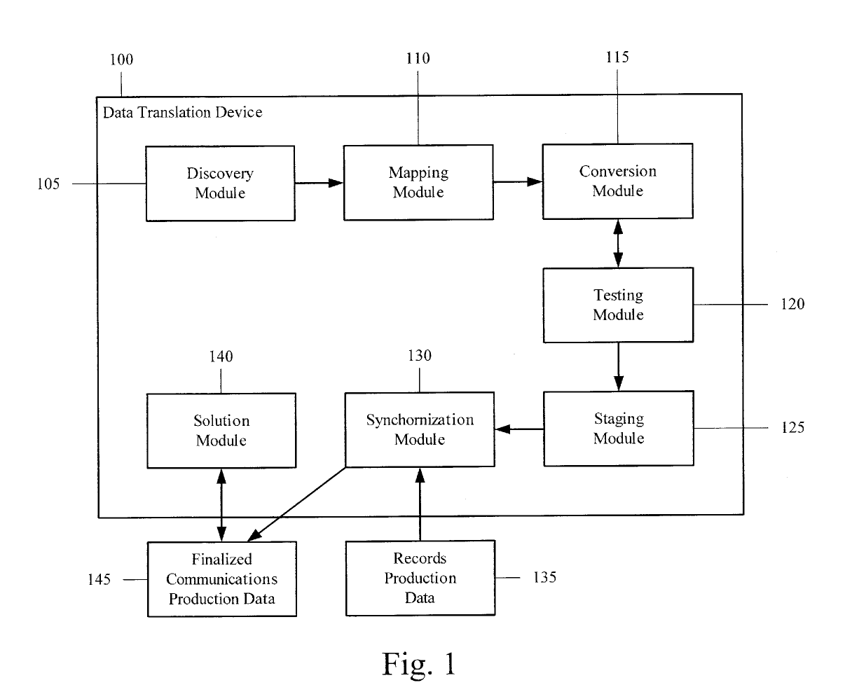

FIG. 1 shows a data translation device 100 according to an exemplary embodiment. The data translation device 100 may provide a staged approach to converting data from a first format to a second format in order to test an application of an engineering design tool (EDT) that requires the data in the second format. As will be described in further detail below, the data translation device 100 may provide the conversion in a manner that reduces a data conversion schedule while also minimizing risk of contaminating the data and/or losing of data. The data translation device 100 may include a discovery module 105, a mapping module 110, a conversion module 115, a testing module 120, a staging module 125, a synchronization module 130, and a solution module 140. Each of these modules will be described in greater detail below.

It should be noted that the data translation device 100 may be modular to be associated with a computing device. For example, the data translation device 100 may be wholly contained in an attachment device that is connected to a server of a network. The attachment may include a processor and memory to perform the conversion of the data according to the exemplary embodiments. It should also be noted that the data translation device 100 may be incorporated with a computing device. For example, the data translation device 100 may be an internal processing component of a server of a network. It should further be noted that the data translation device 100 may be embodied as a program which is installed on a computing device such as a server of a network. The program may include a set of instructions that are executable by a processor of the computing device.

The discovery module 105 may acquire the data that is to be translated for the EDT application. The discovery module 105 may be configured to determine the data that is to be translated. The discovery module 105 may perform this determination automatically or may receive information manually. For example, a translation process may be initiated with a set of parameters. The discovery module 105 may perform a search of databases to determine the data that fits the set of parameters. In another example, an administrator may enter the data that is to be translated. The discovery module 105 may search the databases for the specified data.

The discovery module 105 may further be configured to acquire the source data that is to be translated. For example, the discovery module 105 may receive the source data from various regional databases such as a regional workshop. In another example, further databases such as a records database may extract the data and be transmitted to the discovery module 105. Upon receiving the data, the discovery module 105 may prepare the data for subsequent processes. For example, in the wire center example, the data may be prepared using discrete multi-tone (DMT) modulation.

The mapping module 110 may include a source to target matrix (STM) to provide a high level view of the translation project. The STM may help set a scope, identify gaps and/or overlaps, and demonstrate a complexity of the translation project. The mapping module 110 may receive the prepared data from the discovery module 105 and process the data via the STM. The mapping module 110 may further be configured to modify and/or develop a conversion and validation tool for subsequent processing of the data. For example, the STM may provide rules for the conversion to a rule base. These rules may then be used to generate the conversion tool for the actual conversion. The specific rules will depend on the type of data that is to be converted. Similarly, the rules in the rule base may also be used to validate the conversion using a validation tool. As will be described in greater detail below, the conversion tool and validation tool may be modified based on testing that occurs on the converted data.

The mapping module 110 may further be configured to set up a conversion environment and build a conversion run schedule. For example, the mapping module 110 may include further rules concerning when and/or a specific order for data translation. The mapping module 110 may use these rules to generate the schedule for the conversion. In one example, it may be that a particular subset of data cannot be translated until after another subset of data is translated. Thus, the mapping module 110 will use this information to create the conversion schedule.

The conversion module 115 may run the conversion tool to generate converted data from a first format to a second format. As will be described in greater detail below, the first run of the conversion tool on data may be a small subset of the data for test purposes. Based on this test conversion, the conversion module 115 may also generate updates to the rule base as a function of the conversions that were performed. For example, the update to the rule base may be that the subset of data has been successfully converted and therefore does not need to be converted in further runs. Carrying through with one of the examples described above, the update to the rule base may be that the subset of the data has been successfully converted and therefore other data dependent on this data may be converted. Those skilled in the art will understand that there may be any number of updates that may be made to the rule base after the successful and/or unsuccessful conversion of the data.

The conversion module 115 may be configured to analyze issues and provide resolutions to problems encountered with converting certain data. This analysis may be a manual analysis by project administrator or an automatic analysis. For example, the conversion module 115 may determine that the conversion tool does not provide the converted data in the proper second format (e.g., missing character prefixes, too many trailing characters, missing dashes, etc.). The conversion module 115 may determine if this is a systematic error in the conversion tool and resolve the error by suggesting and/or implementing a change to the conversion too. Where the error is not systematic (e.g., the error only occurs in select data), the conversion module 115 may identify problems with the initial data. In such a case, the conversion module 115 may update the STM via an analysis from the converting. Again, the conversion module 115 may encounter any number of issues with the conversion and resolve these issues based on the nature of the individual issue.

For manual analysis, the conversion module 115 may generate the converted data and provide the converted data to a quality assurance (QA) and/or issue report. Thus, the effectiveness of the conversion may be viewed by administrators to determine a present efficiency of the translation project.

The testing module 120 may be configured to test the converted data. Testing the converted data may provide a quality inspection to verify contamination and/or loss of data. As discussed above, the QA and/or issue report may enable administrators, in particular a QA and/or quality control (QC) team, to provide updates and/or further parameters to be incorporated for the data testing. A further QA/QC report may be generated by the testing module 120 which may be used for issue resolution, if present.

If the testing module 120 determines that there are issues with the conversion of the data, the testing module 120 may return the data with the results to the conversion module 115 to iterate the process until finalized data is reached where no issues are present. Furthermore, the iterative process between the conversion module 115 and the testing module 120 may be broken up into a plurality of processes for different sources of data. For example, if a migration of data from multiple wire centers to an engineering design tool (EDT), the iterative process between the conversion module 115 and the testing module 120 may be performed for each wire center. This may enable the converted data to be stored in an organized manner so subsequent steps may be performed at a smaller scale.

The staging module 125 may migrate the finalized data to a staging process. The staging module 125 may generate staged data from the migration to provide a production validation process to be performed. The validation may provide a determination for the EDT application deployment.

The synchronization module 130 may be configured to validate production as well as inspect data quality. The synchronization module 130 may also receive production data 135 from a records storage to enable the validation and inspection of communications production data (converted data up to this point) to be used with the EDT application. According to the exemplary embodiments, the records production data 135 may be incrementally loaded to the communications production data. The synchronization module 130 may repeatedly perform a data quality inspection and/or correction on the communications production data to generate finalized communications production data 145.

The solution module 140 may run analyses on the finalized communications production data 145. The solution module 140 may be configured to provide a determination when the EDT application development is complete by performing an EDT test on the application. The solution module 140 may also configure a production environment for the EDT application.

According to the exemplary embodiments, the incremental loading of the records production data to the communications production data may provide an accelerated and flexible deployment schedule for the EDT application. Baseline data of the EDT application may be migrated and stored in a production ready communications system with periodic updates from the records production data to the communications production data. In addition, according to the exemplary embodiments, no conversion of data is required during the EDT application cutover. That is, because of the periodic updates with conversions being performed iteratively, the finalized communications production data may be generated by the synchronization module 130. Thus, when the communications system is prepared for cutover, no conversions are required.

Those skilled in the art will understand that according to the exemplary embodiments, disruption to the workforce for a translation project is minimized as an automatically generated conversion schedule (and thus cutover expectation time) may be produced in comparison to a manually determined conversion schedule that is often “to be determined.” As discussed above, no conversions are necessary prior to cutover. Accordingly, the exemplary embodiments may be configured to inspect and fix the data to be translated multiple times prior to production launch.

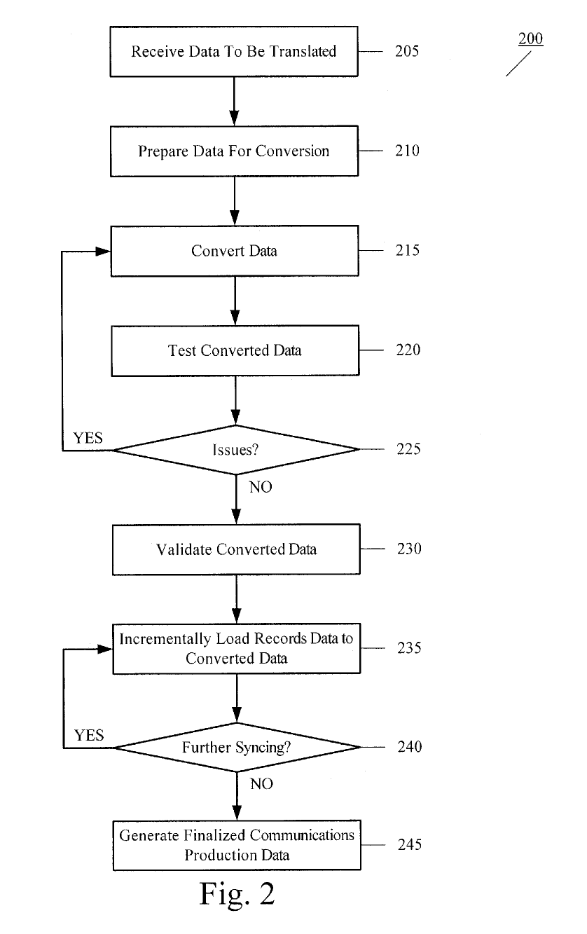

FIG. 2 shows a method 200 for translating data according to an exemplary embodiment. The method 200 may be used to determine when an application of an EDT may be launched based upon a time needed to convert data from a first format to a second format used by the application. The method 200 may will be discussed with reference to the data translation device 100 of FIG. 1.

In step 205, the discovery module 105 receives the data to be translated for the EDT application. As discussed above, the discovery module 105 may initially determine the data that is to be translated automatically (e.g., determined through predefined parameters) or manually (e.g., entered by an administrator). The discovery module 105 may subsequently search for the data from a plurality of databases. The discovery module 105 may also receive source data that is to be translated.

In step 210, the discovery module 105 and the mapping module 110 prepare the data for conversion. As discussed above, the discovery module 105 may be prepared using DMT modulation to be transmitted to the mapping module 110. The mapping module 110 may utilize the STM to process the data from the discovery module 105. The mapping module 110 may further prepare the data by modifying and/or developing a conversion and validation tool for subsequent processing of the data.

In step 215, the conversion module 115 may utilize the conversion tool of the mapping module 110 to convert the data to the format supported by the EDT application. The conversion module 115 may further provide the converted data to a QA and/or issue report to determine a present efficiency of the translation project.

In step 220, the testing module 120 tests the converted data to determine compatibility with the EDT application. As discussed above, the testing may provide a quality inspection to verify contamination and/or loss of data. The verification may be enhanced from the QA and/or issue report generated by the conversion module. The testing module 120 may generate further QA/QC report.

In step 225, the testing module 120 determines if issues are present with the conversion of the data and compatibility of the converted data with the EDT application. The above described QA and/or issue report with the further QA/QC report may assist in this determination. If issues are present, the method 200 returns to step 215 where the data is converted with updated parameters as a function of the reports.

It should be noted that the method 200 may include a plurality of steps 215, 220, 225 when multiple conversions are being conducted. As discussed above, the iterative process of steps 215, 220, 225 may be used for each wire center in which data is to converted.

If no issues are present, the method continues to step 230 where the staging module 125 validates the converted data. As discussed above, the staging module 125 may migrate the finalized data generated by the conversion module 115 and tested by the testing module 120 to a staging process. The staging module 125 may subsequently generated staged data to provide a production validation process to be performed.

In step 235, the synchronization module 130 incrementally loads records data to the converted data (i.e., communications production data). As discussed above, the synchronization module 130 may receive the records production data 135 to be synchronized with the communications production data. In step 240, the synchronization module 130 determines if further synchronizing of the records production data 135 with the communications data is needed. That is, the determination relates to whether the records production data 135 has been fully incorporated with the communications data. If further incremental loading is required, the method 200 returns to step 230.

If the records production data 135 has been fully loaded into the communications production data, the method 200 continues to step 245 where the synchronization module 130 generates the finalized communication production data 145 which is ready to be used with the EDT application.

It should be noted that the method 200 may include additional steps. In a first example, as discussed above, the method 200 may include multiple steps 215, 220, 225 for each wire center in which data is to be translated. In a second example, the method 200 may include a further step in which the solution module 140 runs analyses on the finalized communications production data 145. Additional steps may include the solution module 140 determining when the EDT application development is complete and the solution module 140 configuring a production environment for the EDT application.

According to the exemplary embodiments, the data translation device may be configured to provided a staged approach to data conversion. Data may be converted from a first format to a second format used by an EDT application. Also according to the exemplary embodiments, the staged approach may include an incremental loading of records production data to communications production data. Thus, an accelerated and flexible deployment schedule for the EDT application may be realized as well as baseline data of the EDT application being migrated and stored in a production read communications system with periodic updates. Furthermore, according to the exemplary embodiments, the data translation device enables no further conversions of data to be required prior to the EDT application cutover. The iterative conversions with incremental loading enables the finalized communications production data to be generated prior to the launching of the EDT application.

Those skilled in the art will understand that the above described exemplary embodiments may be implemented in any number of manners, including as a separate software module, as a combination of hardware and software, etc. For example, the data translation device may include modules which may be embodied as a program containing lines of code that are stored in a computer readable storage medium that, when compiled, may be executed on a processor of the compiler 170.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A computer readable storage medium including a set of instructions executable by a processor, the set of instructions operable to:
convert first production data from a first format to a second format; and
incrementally load second production data to the first production data to generate finalized production data, the finalized production data being in the second format.

2. The computer readable storage medium of claim 1, wherein the set of instructions are further operable to:
determine and receive the first production data to be converted.

3. The computer readable storage medium of claim 2, wherein the set of instructions are further operable to:
prepare the first production data to be converted; and
generate information for the converting of the first production data.

4. The computer readable storage medium of claim 1, wherein the set of instructions are further operable to:
test the converted first production data for compatibility in the second format.

5. The computer readable storage medium of claim 4, wherein the converting of the first production data is repeated until the testing determines that the converted first production data is compatible in the second format.

6. The computer readable storage medium of claim 1, wherein the second format is used for an application of an engineering design tool (EDT).

7. The computer readable storage medium of claim 6, wherein the finalized production data is generated prior to a cutover of the application.

8. The computer readable storage medium of claim 6, wherein the set of instructions are further operable to:
perform analyses on the finalized production data.

9. The computer readable storage medium of claim 8, wherein the set of instructions are further operable to:
determine when the application is prepared to be launched as a function of the finalized production data.

10. The computer readable storage medium of claim 1, wherein the set of instructions are further operable to:
convert the second production data to the second format prior to the loading.

11. A device, comprising:
a conversion module converting first production data from a first format to a second format; and
a synchronization module incrementally loading second production data to the first production data to generate finalized production data, the finalized production data being in the second format.

12. The device of claim 11, further comprising:
a discovery module receiving the first production data to be converted.

13. The device of claim 12, further comprising:
a mapping module receiving the first production data from the discovery module and preparing the first production data to be converted, the mapping module further generating information used by the conversion module to base conversions of the first production data.

14. The device of claim 11, further comprising:
a testing module testing the converted first production data for compatibility in the second format.

15. The device of claim 14, wherein the conversion module repeatedly converts the first production data until the testing module determines that the converted first production data is compatible in the second format.

16. The device of claim 11, wherein the second format is used for an application of an engineering design tool (EDT).

17. The device of claim 16, wherein the finalized production data is generated prior to a cutover of the application.

18. The device of claim 16, further comprising:
a solution module running analyses on the finalized production data.

19. The device of claim 18, wherein the solution module determines when the application is prepared to be launched as a function of the finalized production data.

20. A device, comprising:
a conversion means for converting first production data from a first format to a second format and
a synchronization means for incrementally loading second production data to the first production data to generate finalized production data, the finalized production data being in the second format.
